(19) United States
(12) Patent Application Publication
(10) Pub. No.: US 2006/0105088 A1
(43) Pub. Date: May 18, 2006

(54) Gelled food product and method of making the same

(76) Inventor: Jose H. Salgado, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 10/991,294

(22) Filed: Nov. 17, 2004

(51) Int. Cl. A23L 1/05

(52) U.S. Cl. 426/573

(57) ABSTRACT

A gelled food product similar in texture to gelatine but containing ingredients similar to pudding or flan comprises milk, cinnamon, sugar, pecans and dissolved corn starch as the gelling agent. Flavoring agents such as strawberry, cherry, vanilla and coconut can be added and ground cinnamon can be placed on top. A method of making the gelled food product includes the step of warming a quantity of milk over a low heat, adding a stick of cinnamon, then adding sugar, pecans and a food preservative to the warming milk. Preferably, corn starch is used as the gelling agent and is added after being dissolved in a removed portion of the warm milk, which is then added back in to form a gellable mixture. After boiling, the mixture is prepared for consumption by separating into single serving sized containers and then cooled. Flavoring agents and/or ground cinnamon can also be added.

### CROSS-REFERENCE TO RELATED APPLICATIONS

None.

### BACKGROUND OF THE INVENTION

A. Field of the Invention

The field of the present invention relates generally to food products and methods of making food products. More particularly, the present invention relates to gelled food products and, more specifically, to a gelatin-like dessert or snack food product. Even more particularly the present invention relates to such gelled food products that can be made with a variety of flavored food additives to provide different flavored food products.

B. Background

As is well known in the food industry, dessert and snack food products are very popular with consumers and, as a result, a wide variety of such products are commonly available. Dessert and snack food products include such desserts as gelatins, such as JELL-O (a registered trademark of Kraft Foods Holdings, Inc.), puddings and flans, a product similar in consistency to pudding that is typically made from milk and certain colloids. With regard to gelatin products, JELL-O is believed to be the most popular gelatine product sold in the United States and, perhaps, the world. As is well known, gelatine products are available in a variety of fruit and non-fruit flavors. Although many gelatine products are available in a powder mix form, in which the consumer adds hot or warm liquid to the powder to complete the gelled product, they are also available in ready-to-eat forms. Pudding and flan products are also sold to consumers in both mix and read-to-eat forms and are available in a variety of fruit and non-fruit flavors. In general, gelatin and gelatin-type of products are of a slightly stiffer or harder consistency, though not hard in the sense of hard candy and the like, than pudding and flan products.

In addition to common gelatin, pudding and flan products, a number of such products are described in various prior art patents. For instance, U.S. Pat. No. 6,607,776 to Howard, et al. describes a protein enhanced gelatin-like dessert that comprises a gelling system plus flavorings, colorings, nutritional additives and various proteins. U.S. Pat. No. 6,258,397 to Flynn describes a dessert product comprising an aerated cream or cream cheese mixed with a hot gelatine solution that is allowed to set such that it maintains the aerated structure. U.S. Pat. No. 4,500,552 to Kadison, et al. describes a gelatin dessert product that forms, in a single step, a clearly demarcated two-layered, two-colored dessert. U.S. Pat. No. 6,183,801 to Warendorf describes a gelled food composition containing fruit pieces that is provided in a sealed container. U.S. Pat. No. 4,722,851 to Kadan et al. describes a flan-type of pudding that uses cereal flour to improve the nutritional value of the product. U.S. Pat. No. 4,919,958 to Kadan et al. describes flan-type pudding having an egg-free composition comprising rice flour, tetra potassium pyrophosphate, pectin and whey protein isolate or xanthane gum.

As stated above, many gelatin, pudding and flan products are available to the consumer in ready-to-eat forms. Although such ready-to-eat products can be provided in any variety of different sized and types of containers, a common form for producers of such products is to provide them in generally single serving sized containers (i.e., approximately one to two ounces). Typically, these containers are made of plastic or plastic-like materials that have a sealed, but removable, foil, plastic or other material top that the consumer peels off or otherwise removes to gain access to the dessert product inside the container. Generally, these containers are made to be disposable and easily accessed by children as well as adults.

Although there are a number of gelatine, pudding and flan type of products commonly available, there is always a need or desire for a new dessert or snack food product. Accordingly, what is needed is a new gelled food product that is in the nature of a gelatine-type of dessert or snack food. A preferred new gelled food product should be one that provides some of the desired textural features of the various gelatin desserts and snacks and comprise many of the same ingredients as those utilized for many pudding and flan products. The preferred gelled food product should include a method of making the same that provides the ability to mass produce quantities of the product and which is suitable for placing the product in single size serving containers. The preferred gelled food product should also be adapted for mixing with various flavorings to provide different flavors of the product.

### SUMMARY OF THE INVENTION

The gelled food product and method of making the same of the present invention solves the problems and provides the benefits identified above. That is to say, the present invention discloses a new gelled dessert or snack food product that is similar in consistency to gelatine and gelatine-like products and which is made of ingredients similar to those utilized for pudding and/or flan. The present invention also describes a method of making such a product. The gelled food product of the present invention is adaptable for mass production of the product into a ready-to-eat form and placement of the product in single serving sized containers, such as those commonly utilized in the food industry for gelatine, pudding and flan dessert and snack food products.

In one general aspect of the present invention, the gelled food product of the present invention includes a liquid dairy product such as milk, a source of cinnamon such as a cinnamon stick, a sugar such as white sugar, a quantity of nuts such as pecans and a dairy-based gelling agent, such as dissolved corn starch. In the preferred embodiment, the gelled food product also includes a food preservative, such as potassium sorbate, and a quantity of ground cinnamon on top. In an alternative embodiment, the gelled food product also includes a flavoring agent, such as extracts or imitations of strawberry, cherry, vanilla and coconut flavors.

In a general aspect of a method of making the gelled food product of the present invention, the gelled food product is made by placing a quantity of liquid dairy product, such as milk, into a cooking container and placing the container over a low heat to warm the liquid dairy product. Cinnamon is added to the warming liquid dairy product, preferably in the form of a cinnamon stick. A quantity of sugar, such as white sugar, is then added to the liquid dairy product. A quantity of nuts, preferably pecans, is also added to the liquid dairy product. To extend “shelf” life of the product, a quantity of food preservative, such as potassium sorbate, is also added to the warming liquid dairy product. A dairy-based gelling agent is added to the liquid dairy product to form a gellable mixture. A preferred gelling agent is corn starch, which is dissolved in a quantity of the liquid dairy product prior to adding to the cooking container. The gellable mixture is stirred and the heat is increased to boil the gellable mixture for approximately five minutes. The product is finalized by cooling. In the preferred embodiment, the gellable mixture is poured into small, single serving sized containers prior to cooling and these smaller containers are sealed with a removable lid or top. Also in the preferred embodiment, ground cinnamon is added to the top of the gelled food product.

A more specific method of making the gelled food product of the present invention includes placing a quantity of milk into a cooking container and then warming the milk over a low heat. A quantity of cinnamon, preferably in the form of a cinnamon stick, is added to the milk. A quantity of white sugar is then added to the warming milk, followed by adding a quantity of pecans to the milk. A food preservative, such as potassium sorbate, is then added to the milk. A portion of the milk from the cooking container is placed into a second container where a quantity of corn starch, as the gelling agent, is added and dissolved to form a gelling mixture. The gelling mixture is then poured back into the cooking container where it is mixed with the milk to form a gellable mixture. The gellable mixture is continuously stirred while the gellable mixture is brought to a boil for approximately five minutes. The gellable mixture is then cooled to form the gelled food product of the present invention. Prior to cooling, the gellable mixture can be placed into single serving sized containers. If desired, a flavoring agent can be added to the gellable mixture prior to bring into boil. In the preferred embodiment, ground cinnamon is placed on top of the gelled food product.

Accordingly, the primary objective of the present invention is to provide a gelled food product and method of making the same that is a new dessert and snack food product having the advantages discussed above.

It is also an object of the present invention to provide a new gelled food product that is similar in texture to gelatine or gelatine-type food products but which has many of the same ingredients as a pudding or flan product.

It is also an object of the present invention to provide a new gelled food product that is made from milk, cinnamon, sugar, pecans and corn starch.

It is also an object of the present invention to provide a new gelled food product that is suitable for being made in mass quantities and placed into containers for the consumer in a ready-to-eat form.

It is also an object of the present invention to provide a new gelled food product that is made by warming a quantity of milk under a low heat and then adding one-fourth an ounce of cinnamon stick, two cups of white sugar, one-half cup of pecans and potassium sorbate, then adding four cups of dissolved corn starch to the mixture and bringing the mixture to boil for five minutes while continuously stirring.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is front view of the gelled food product of the present invention in a single serving sized container having a peelable-type of container top; and

FIG. 2 is a chart summarizing a preferred method of making the gelled food product of the present invention.

### DETAILED DESCRIPTION OF THE PREFERRED EMBODIMENTS

With reference to the figures where like elements have been given like numerical designations to facilitate the reader's understanding of the present invention, and particularly with reference to the embodiment of the gelled food product and method of making the same of the present invention illustrated in the figures, various preferred embodiments of the present invention are set forth below. The enclosed description and drawings are merely illustrative of preferred embodiments and represent several different ways of configuring the present invention. Although specific ingredients, materials, configurations and uses of the present invention are illustrated and set forth in this disclosure, it should be understood that a number of variations to the ingredients and to the mixture of those ingredients described herein and in the accompanying figures can be made without changing the scope and function of the invention set forth herein.

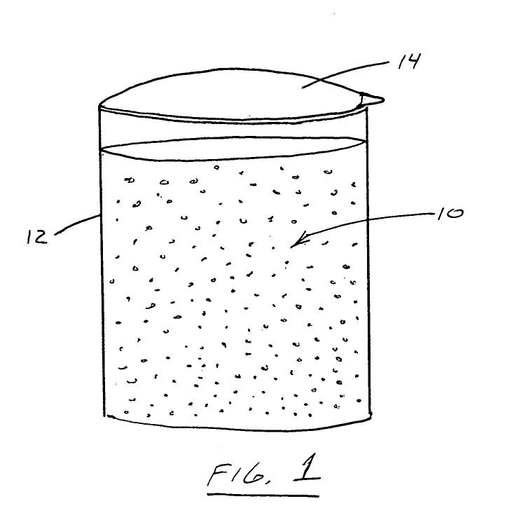

In the preferred embodiment of the gelled food product and method of making the same of the present invention, the gelled food product is identified generally as 10 in FIG. 1. As explained in more detail below, gelled food product 10 can be provided to the consumer in single serving sized containers 12 having a peelable or otherwise removable sealed lid 14 that encloses gelled food product 10 and protects it from contamination until it is ready to be eaten by the consumer. Although FIG. 1 shows use of the gelled food product 10 of the present invention being made available in a single serving sized container 12, those skilled in the art will readily recognize that the present invention is not so limited. If desired, gelled food product 10 of the present invention can be provided to the consumer in smaller or larger sized containers than what would normally be considered a single size serving.

Generally, the gelled food product 10 of the present invention is formulated from a liquid dairy product such as milk, a quantity of cinnamon, sugar, nuts such as pecans and corn starch (as the gelling agent). Ground cinnamon can be added, such as by dropping or sprinkling, to the top of the finished product as desired. Potassium sorbate is utilized as a food preservative. The ingredients for the gelled food product 10 of the present invention are all generally available and of reasonable cost, such that the product 10 can be made by a person skilled in the art without any undo difficultly in a cost effective manner. As set forth below, the above ingredients are prepared and mixed in a designated manner to achieve the desired gelled food product 10 for placement into containers 12 and then sealed by lid 14 to be sold to the consumer. In addition to the above ingredients, a wide variety of flavoring and/or coloring agents, such as those utilized in conventional gelatin dessert products, can be utilized with the gelled food product 10 of the present invention to provide a variety of tastes as may appeal to consumers generally. Typical flavoring agents for the gelled food product 10 include strawberry, cherry, vanilla and coconut, although other flavoring agents can be also utilized to provide other flavors as desired by the consumer. The flavoring agents can be provided in extract or imitation form. Although the above text and the preparation methods set forth below describe the preferred gelled food product 10, it is well known that, as with generally all food products, the gelled food product 10 of the present invention can be altered to accommodate individual consumer taste. While it is believed that the disclosure herein incorporates some of the variations believed possible for gelled food product 10, it is likely that other variations to that set forth below can be identified with further investigation and trials.

The following example of a method of manufacturing the gelled food product 10 according to the preferred embodiment of the present invention incorporates the following ingredients:

| Ingredient | Quantity Necessary | |
|---|---|---|
| Milk | 1 | gallon |
| Cinnamon Stick | ¼ | ounce stick |
| White sugar | 2 | cups |
| Pecan nuts (pieces) | ½ | cup |
| White corn starch | 4 | cups |

| | |
|---|---|
| Ground cinnamon | As desired to taste |

The above ingredients are based on the use of one gallon of milk as the “base” ingredient. For larger or smaller quantities of the product, more or less milk is utilized and more or less of the other ingredients are also utilized (i.e., for a quantity based on ten gallons of milk, the other ingredients would also increase ten-fold). In addition to the above ingredients, a sufficient quantity of a food based preservative, such as potassium sorbate, is added in a quantity dependent on the preservative chosen, as is generally well known to those skilled in the art. As may be further recognized by those skilled in the art, when properly prepared the gelled food product 10 of the present invention will be a sweet and gelatinous product (i.e., hard in the sense of a gelatin product such as JELL-O, but not hard in the sense of hard candy or other hard solid product).

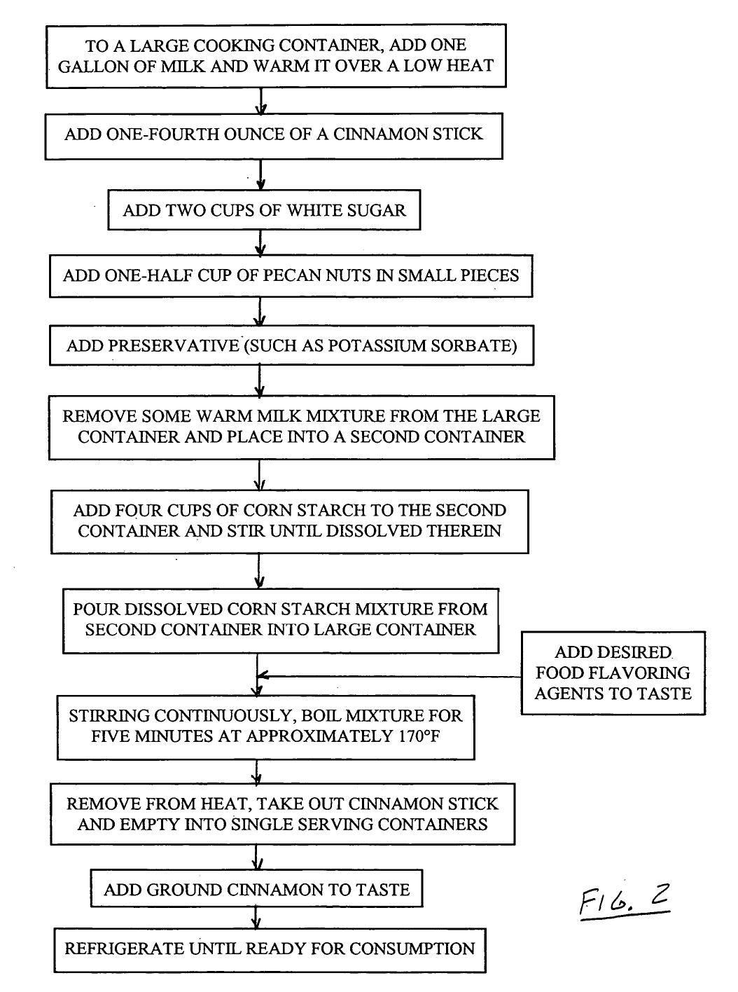

The method of making the gelled food product 10 of the present invention, summarized in the chart in FIG. 2, is as follows:

In a sufficiently large sized, stove or other heat suitable cooking container, pour in one gallon of milk and place it over a low heat (i.e., slow fire). Add the one-fourth ounce of a cinnamon stick to the warming milk and then add the two cups of white sugar. Add the one-half cup of pecan nuts to the above mixture. Preferably, the pecan nuts are provided in small pieces, shown as 16 in FIG. 1, so that they can more easily disperse or intermix in the milk mixture. Add the food preservative, such as potassium sorbate, in a quantity sufficient for the one gallon of milk mixture. After the milk has warmed, remove a portion of the warm milk mixture from the large cooking container and place it in a second, generally smaller, container. Pour the four cups of white corn starch, which serves as the gelling agent, into the portion of the warm milk mixture that is in the second container and stir as necessary to dissolve the corn starch therein to form a gelling mixture. Once the corn starch is dissolved, pour the gelling mixture from the second container into milk in the large cooking container and stir to mix the materials together in the large cooking container to form a gellable mixture. Continuously stir the gellable mixture in the large cooking container over heat at approximately 170 degrees Fahrenheit until the gellable mixture boils (care being taken to avoid burning or boiling away the mixture by the use of too high of heat). After continually stirring the gellable mixture at boil for approximately five minutes, turn of the heat and/or remove the large cooking container from the heat source. Remove the remainder of the cinnamon stick (i.e., that portion which has not dissolved in the mixture to this point) from the gellable mixture and, in the preferred embodiment, pour the hot/warm gellable mixture from the large cooking container into smaller, single serving size containers (i.e., one or two ounce containers or as otherwise may be desired), such as 12 in FIG. 1. Add some of the ground cinnamon to the top of the mixture in the single serving containers 12 as desired for individual taste. In the preferred embodiment, the container is then sealed with removable lid 14. Cool, preferably by refrigeration, the mixture to obtain the gelled food product 10 of the present invention. Gelled food product 10 should be refrigerated, typically between 33 and 40 degrees Fahrenheit, until ready for consumption. In a preferred embodiment described above, the recipe will provide enough gelled food product 10 for 14 single serving containers 12 of approximately one cup (236 ml) each.

In an alternative form of the present invention, food flavoring agents or additives are added to the mixture to provide a different flavor. Examples of preferred flavoring agents are strawberry, cherry, vanilla and coconut. These, or other flavoring agents, can be added in extract form or imitation flavoring agents can be utilized. As shown in FIG. 2, in a preferred method of making the gelled food product 10 of the present invention, the food agent is added to the gellable mixture after the dissolved corn starch is added to the large cooking container from the small cooking container and is stirred into the mixture with the dissolved corn starch.

While there are shown and described herein certain specific alternative forms of the invention, it will be readily apparent to those skilled in the art that the invention is not so limited, but is susceptible to various modifications and rearrangements in ingredients and materials without departing from the spirit and scope of the invention. In particular, it should be noted that the present invention is subject to modification with regard to materials, size, shape and use. For instance, some of the ingredients described above can be replaced by other ingredients that perform the same function as those described above.

What is claimed is:

1. A gelled food product, comprising a liquid dairy product, a source of cinnamon, a sugar, a quantity of nuts and a dairy-based gelling agent.

2. The gelled food product according to claim 1, wherein said liquid dairy product is milk and said sugar is white sugar.

3. The gelled food product according to claim 2, wherein said quantity of nuts comprises pecans.

4. The gelled food product according to claim 3, wherein said diary-based gelling agent is corn starch.

5. The gelled food product according to claim 4, further comprising a flavoring agent.

6. The gelled food product according to claim 5, wherein said flavoring agent is selected from the group consisting of strawberry, cherry, vanilla and coconut flavors.

7. The gelled food product according to claim 3, further comprising a food preservative.

8. The gelled food product according to claim 1, wherein said dairy-based gelling agent is corn starch dissolved in said liquid dairy product.

9. The gelled food product according to claim 8 further comprising a flavoring agent selected from the group consisting of strawberry, cherry, vanilla and coconut flavors.

10. The gelled food product according to claim 1, further comprising a food preservative and a flavoring agent.

11. The gelled food product according to claim 10, wherein said flavoring agent is selected from the group consisting of strawberry, cherry, vanilla and coconut flavors.

12. A method of making a gelled food product, comprising the steps of;
A) placing a quantity of liquid dairy product into a cooking container;
B) warming said quantity of liquid dairy product over a low heat;
C) adding a quantity of cinnamon said quantity of liquid dairy product;
D) adding a quantity of sugar to said quantity of liquid dairy product;
E) adding a quantity of nuts to said quantity of liquid dairy product;
F) adding a food preservative to said quantity of liquid dairy product;
G) adding a dairy-based gelling agent to said quantity of liquid dairy product to form a gellable mixture;
H) stirring said gellable mixture and increasing said low heat to boil said gellable mixture; and
I) cooling said gellable mixture.

13. The method according to claim 12, wherein said liquid dairy product is milk, said sugar is white sugar and said nuts comprises pecans.

14. The method according to claim 12, wherein said dairy-based gelling agent is dissolved in a quantity of said liquid dairy product prior to said gelling agent adding step.

15. The method according to claim 14, wherein said dairy-based gelling agent is corn starch.

16. The method according to claim 12 further comprising the step of removing a portion of said quantity of liquid dairy product, placing said portion into a second container and dissolving said dairy-based gelling agent in said portion prior to said gelling agent adding step.

17. The method according to claim 16, wherein said dairy-based gelling agent is corn starch.

18. The method according to claim 12 further comprising the step of adding a flavoring agent to said gellable mixture prior to said stirring step.

19. A method of making a gelled food product, comprising the steps of;
A) placing a quantity of milk into a cooking container;
B) warming said quantity of milk over a low heat;
C) adding a quantity of cinnamon to said quantity of milk;
D) adding a quantity of sugar to said quantity of milk;
E) adding a quantity of pecans to said quantity of milk;
F) adding a food preservative to said quantity of milk;
G) removing a portion of said quantity of milk from said cooking container, placing said portion into a second container and dissolving a quantity of corn starch in said portion to form a gelling mixture;
H) adding said gelling mixture to said quantity of milk to form a gellable mixture;
I) stirring said gellable mixture and increasing said low heat to boil said gellable mixture; and
J) cooling said gellable mixture.

20. The method according to claim 19 further comprising the step of adding a flavoring agent to said gellable mixture prior to said stirring step.
